(19) United States
(12) Patent Application Publication
(10) Pub. No.: US 2014/0021416 A1
(43) Pub. Date: Jan. 23, 2014

(54) THERMOPLASTIC RESIN COMPOSITION

(71) Applicant: Olympus Corporation, Tokyo (JP)

(72) Inventors: KOHEI OGUNI, Tokyo (JP); Naoyuki Osako, Tokyo (JP); Takeshi Kida, Tokyo (JP)

(73) Assignee: Olympus Corporation, Tokyo (JP)

(21) Appl. No.: 14/025,257

(22) Filed: Sep. 12, 2013

Related U.S. Application Data
(63) Continuation of application No. PCT/JP2012/066037, filed on Jun. 22, 2012.

(30) Foreign Application Priority Data
Jul. 1, 2011 (JP) 2011-147169

(51) Int. Cl. H01B 1/24

(52) U.S. Cl. CPC H01B 1/24
USPC 252/511

(57) ABSTRACT

The thermoplastic resin composition includes 30 to 80 parts by mass of a polyamide, 20 to 70 parts by mass of a thermoplastic fluorine resin, and a carbon fiber. Also, a total sum of the polyamide and the thermoplastic fluorine resin is 100 parts by mass, an amount of the carbon fiber is 5 to 50 parts by mass based on 100 parts by mass of the total sum of the polyamide and the thermoplastic fluorine resin. The thermoplastic fluorine resin has a tensile elongation of equal to or greater than 450%, and a tensile stress of equal to or greater than 5 MPa.

The present application is a Continuation of International Patent Application No. PCT/JP2012/066037, filed Jun. 22, 2012, claiming priority on Japanese Patent Application No. 2011-147169, filed in Japan on Jul. 1, 2011, the contents of said Japanese Patent Application and said PCT Application being incorporated herein.

### BACKGROUND OF THE INVENTION

1. Field of the Invention

The present invention relates to a thermoplastic resin composition.

2. Description of Related Art

For example, as a member used for a gasoline tank or the like, a thermoplastic resin having oil resistance, impact resistance, and conductivity useful for preventing ignition caused by static electricity or the like is used in many cases.

A conductive filler may be added to provide conductivity for the thermoplastic resin.

For example, Japanese Patent No. 4162201 proposes a thermoplastic resin composition which has satisfactory oil resistance, impact resistance, and conductivity by using a polyamide having oil resistance, polyphenylene ether (PPE) or styrene-ethylene-butylene-styrene block copolymer (SEBS) having impact resistance, and a conductive filler in combination.

### SUMMARY OF THE INVENTION

A thermoplastic resin composition according to a first aspect of the present invention, the thermoplastic resin composition includes 30 to 80 parts by mass of a polyamide, 20 to 70 parts by mass of a thermoplastic fluorine resin, and a carbon fiber. Further, in the thermoplastic resin composition, a total sum of the polyamide and the thermoplastic fluorine resin is 100 parts by mass, an amount of the carbon fiber is 5 to 50 parts by mass based on 100 parts by mass of the total sum of the polyamide and the thermoplastic fluorine resin, and the thermoplastic fluorine resin has tensile elongation of equal to or greater than 450%, and tensile stress of equal to or greater than 5 MPa.

According to a second aspect of the present invention, in the thermoplastic resin composition according to the first aspect, the carbon fiber may have an average fiber diameter of 0.01 to 50 μm and an aspect ratio (i.e., average fiber length/average fiber diameter) of 10 to 200.

According to a third aspect of the present invention, in the thermoplastic resin composition according to the first aspect or the second aspect, the thermoplastic resin composition may have a phase separated structure of a sea-island-like shape in which the thermoplastic fluorine resin is dispersed in the polyamide, and the thermoplastic fluorine resin may have an average particle size of equal to or smaller than 10 μm.

According to a fourth aspect of the present invention, in the thermoplastic resin composition according to the first aspect or the second aspect, the thermoplastic resin composition may have a phase separated structure in which a bicontinuous structure of the thermoplastic fluorine resin and the polyamide is formed, and the polyamide may have an average interphase distance of 10 μm or smaller.

### BRIEF DESCRIPTION OF THE DRAWINGS

FIG. 1 is a schematic view schematically showing one example of a sea-island structure.

FIG. 2 is a schematic view schematically showing one example of a bicontinuous structure.

### DETAILED DESCRIPTION OF THE INVENTION

Embodiments according to the present invention will be described in detail below.

A thermoplastic resin composition according to the embodiments includes a polyamide, a thermoplastic fluorine resin, and a carbon fiber.

### (Polyamide)

The polyamide mainly serves to provide oil resistance for the thermoplastic resin composition.

Examples of the polyamide include an aliphatic polyamide, an aromatic polyamide, and the like.

Examples of the aliphatic polyamide include nylon 6, nylon 11, nylon 12, nylon 66, nylon 610, and the like.

Examples of the aromatic polyamide include a polyamide formed by a condensation of the aliphatic dicarboxylic acid and the aromatic diamine, and the like. Specific examples of the aliphatic dicarboxylic acid include adipic acid, suberic acid, sebacic acid, dodecanoic diacid, and the like. Specific examples of the aromatic diamine include meta-xylene diamine, para-xylene diamine, and the like.

Even among these, from the viewpoint of workability, suitability of synthesis of raw materials, and elongation flexibility, an aliphatic polyamine is preferable, and nylon 11 and nylon 12 are particularly preferable.

For these polyamides, one kind of polyamide may be used alone. Alternatively, two or more kinds of polyamides may be used in combination.

### (Thermoplastic Fluorine Resin)

The thermoplastic fluorine resin mainly serves to provide impact resistance for the thermoplastic resin composition.

The thermoplastic fluorine resin to be used for the embodiment is a resin having a tensile elongation of equal to or greater than 450% and a tensile stress of equal to or greater than 5 MPa.

When the thermoplastic fluorine resin has the tensile elongation of equal to or greater than 450%, the thermoplastic resin composition having satisfactory impact resistance may be obtained. The tensile elongation of the thermoplastic fluorine resin is preferably equal to or greater than 500%.

The tensile elongation of the thermoplastic fluorine resin is a value measured according to ASTM D638.

Further, when the thermoplastic fluorine resin has the tensile stress of equal to or higher than 5 MPa, the thermoplastic resin composition having satisfactory impact resistance may be obtained. The tensile stress of the thermoplastic fluorine resin is preferably equal to or greater than 10 MPa.

The tensile stress of the thermoplastic fluorine resin is a value measured according to ASTM D638.

Examples of the thermoplastic fluorine resin include a tetrafluoroethylene-hexafluoropropylene-vinylidenefluoride copolymer (THV), a tetrafluoroethylene-ethylene copolymer (ETFE), a tetrafluoroethylene homopolymer (PTFE), a tetrafluoroethylene-perfluoroalkoxyethylene copolymer (PFA), a tetrafluoroethylene-hexafluoropropylene-perfluoroalkylvinylether copolymer (EPE), a tetrafluoroethylene-hexafluoropropylene copolymer (FPE), a chlorotrifluoroethylene homopolymer (PCTFE), a chlorotrifluoroethylene-ethylene copolymer (ECTFE), a vinylidenefluoride homopolymer (PVDF), and the like.

Even among these, from the viewpoint of tensile elongation and tensile stress, the THV and the ETFE are preferable.

For these thermoplastic fluorine resins, one kind of thermoplastic fluorine resin may be used alone. Alternatively, two or more kinds of thermoplastic fluorine resins may be used in combination.

### (Carbon Fiber)

The carbon fiber mainly serves to provide conductivity for the thermoplastic resin composition.

The carbon fiber which is present in the thermoplastic resin composition according to the embodiment preferably has an average fiber diameter of 0.01 to 50 and preferably has an aspect ratio (i.e., average fiber length/average fiber diameter) of 10 to 200.

When the average fiber diameter of the carbon fiber is equal to or larger than 0.01 μm, the thermoplastic resin composition may be easily prepared without significantly reducing the aspect ratio. On the other hand, when the average fiber diameter of the carbon fiber is equal to or smaller than 50 μm, the conductivity may be obtained by adding a small amount of the carbon fiber, and conductivity is easily compatible with impact resistance. The average fiber diameter of the carbon fiber is more preferably 0.1 to 10 μm.

Further, when the aspect ratio of the carbon fiber in the thermoplastic resin composition is equal to or greater than 10 or higher, the conductivity may be obtained by adding a small amount of the carbon fiber. On the other hand, when the aspect ratio of the carbon fiber is 200 or lower, the thermoplastic resin composition may be easily prepared. The aspect ratio of the carbon fiber is more preferably 20 to 80.

The average fiber diameter and aspect ratio of the carbon fiber are values obtained by observing the carbon fiber present in the thermoplastic resin composition with a scanning electronic microscope or the like and analyzing the carbon fiber with a commercial image analysis apparatus or the like.

Examples of the carbon fiber include a polyacrylonitrile-based carbon fiber, a rayon-based carbon fiber, a lignin-based carbon fiber, a pitch-based carbon fiber, a carbon nanotube, and the like.

For these carbon fibers, one kind of carbon fiber may be used alone. Alternatively, two or more kinds of carbon fibers may be used.

### (Other Components)

The thermoplastic resin composition according to the embodiment may contain other components if necessary so long as they do not interfere with the effects of the present invention.

Examples of the other components include retardants, releasing agents, pigments, and the like.

### (Blending Ratio)

The thermoplastic resin composition according to the embodiment includes 30 to 80 parts by mass of the polyamide and 20 to 70 parts by mass of the thermoplastic fluorine resin, in which the total sum of the polyamide and thermoplastic fluorine resin is 100 parts by mass.

When a ratio of the polyamide is less than 30 parts by mass and a ratio of the thermoplastic fluorine resin is more than 70 parts by mass, the carbon fiber is hardly dispersed in the thermoplastic resin composition, so that workability and moldability may be decreased. On the other hand, when a ratio of the polyamide is more than 80 parts by mass and a ratio of the thermoplastic fluorine resin is less than 20 parts by mass, the impact resistance of the thermoplastic resin composition may be decreased.

Further, the thermoplastic resin composition according to the embodiment may contain 5 to 50 parts by mass of the carbon fiber based on 100 parts by mass of the total sum of the polyamide and the thermoplastic fluorine resin.

When the amount of the carbon fiber is within the range described above, since the thermoplastic resin composition having a surface resistivity of equal to or lower than 1×10⁹ Ω/sq. is obtained, satisfactory conductivity may be exhibited.

When the amount of the carbon fiber is less than 5 parts by mass, the conductivity of the thermoplastic resin composition may be decreased. On the other hand, when the amount of the carbon fiber is more than 50 parts by mass, the ratio of the thermoplastic fluorine resin to the entire thermoplastic resin composition should be lowered, so that the impact resistance of the thermoplastic resin composition may be decreased.

From the viewpoint of the further improvement of the conductivity and impact resistance of the thermoplastic resin composition, the amount of the carbon fiber is preferably 10 to 35 parts by mass.

### (Preparation Method)

The thermoplastic resin composition according to the embodiment may be prepared by a variety of known methods. For example, the thermoplastic resin composition may be obtained by blending the polyamide, the thermoplastic fluorine resin, the carbon fiber, and if necessary, other components with a kneading apparatus such as a biaxial roll, a kneader, or a banbury mixer.

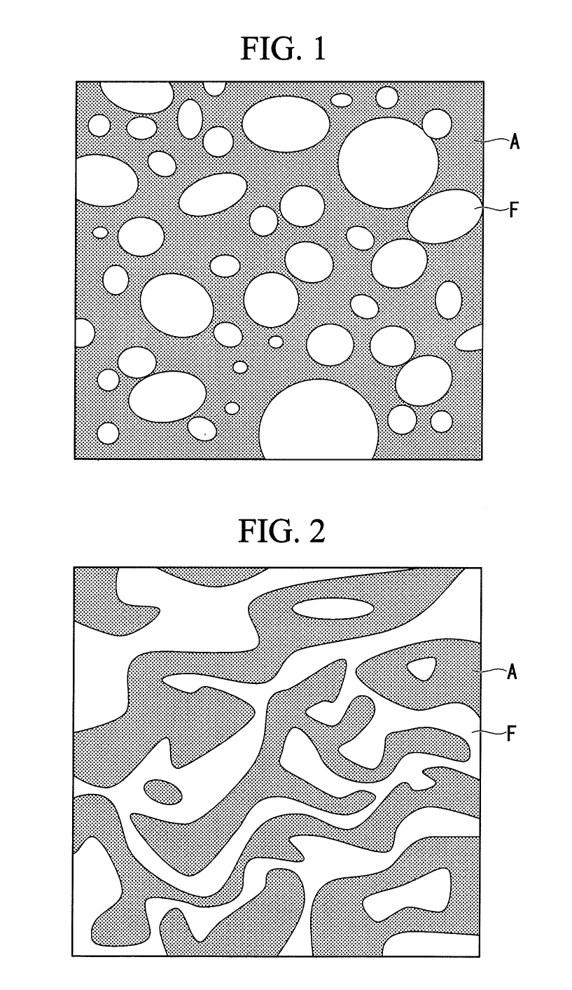

The thermoplastic resin composition obtained in this way preferably includes a phase separated structure of the sea-island shape in which the thermoplastic fluorine resin F is dispersed in the polyamide A as shown in FIG. 1 or a phase separated structure of the bicontinuous structure which is formed by the polyamide A and the thermoplastic fluorine resin F as shown FIG. 2. When the thermoplastic resin composition has the phase separated structure described above, impact energy is absorbed at the interface of the phase separated structure when impact is applied, and thus impact resistance is further improved.

In the phase separated structure of the sea-island shape in which the thermoplastic fluorine resin (dispersed phase) is dispersed in the polyamide (continuous phase), the thermoplastic fluorine resin (dispersed phase) preferably has an average particle size of equal to or smaller than 10 μm, and more preferably 0.01 to 10 μm. As long as the average particle size of the dispersed phase is equal to or smaller than 10 μm, the interface area between the polyamide and the thermoplastic fluorine resin increases, and thus impact resistance is improved more. On the other hand, when the average particle size of the thermoplastic fluorine resin is equal to or larger than 0.01 μm, the thermoplastic resin composition may be easily prepared.

In the phase separated structure of the bicontinuous structure which is formed by the polyamide and the thermoplastic fluorine resin, the polyamide preferably has an average interphase distance of equal to or smaller than 10 μm, and more preferably 0.01 to 10 μm. When the average interphase distance of the polyamide is equal to or smaller than 10 μm, the interface area between the polyamide and the thermoplastic fluorine resin increases, and thus impact resistance is further improved. On the other hand, when the average interphase distance or the polyamide is equal to or larger than 0.01 μm, the thermoplastic resin composition may be easily prepared.

The average particle size of the thermoplastic fluorine resin and the average interphase distance of the polyamide are values obtained by observing the cross-section of the resin in the molded article with a scanning electron microscope or the like and analyzing the cross-section with a commercial image analysis apparatus or the like.

In addition, the phase separated structure is easily exhibited when high shear kneading is performed in a process of preparation of the thermoplastic resin composition. Further, the state of the phase separated structure may be controlled by adjusting the blending ratio of the thermoplastic fluorine resin and the blending ratio of the polyamide. For example, when the blending ratio of the polyamide is increased, the phase separated structure of the sea-island shape is easily formed. Also, when the blending ratio of the thermoplastic fluorine resin is increased, the bicontinuous structure is easily formed by the polyamide and the thermoplastic fluorine resin.

Since the thermoplastic resin composition according to the embodiment described above contains the polyamide and the specific thermoplastic fluorine resin and the carbon fiber at specific amounts, it may have good oil resistance, particularly, good gasoline resistance, good impact resistance, and good conductivity.

The thermoplastic resin composition according to the embodiment may be formed in a molded article having a desirable shape by a general molding method such as injection molding or extrusion molding.

The thermoplastic resin composition according to the embodiment may be used in various applications, but since it has good oil resistance (particularly, gasoline resistance), good impact resistance, and good conductivity, the thermoplastic resin composition is particularly suitable as a material of a member such as a gasoline tank, or a facility or an apparatus to be used in the presence of a flammable gas such as gasoline.

### EXAMPLES

Examples of the present invention will be described in detail below, but the present invention is not limited thereto.

Raw materials and evaluation methods to be used in Examples and Comparative Examples are as follows.

### (Raw Materials)

### <Polyamide>

PA11-A: nylon 11 (Model number: Rilsan B BMN 0TLD, manufactured by Arkema S.A.).
PA11-B: nylon 11 (Model number: MB3000, manufactured by Arkema S.A.).
PA12: nylon 12 (Model number: Rilsan AAMN, manufactured by Arkema S.A.).
PA66: nylon 66 (Model number: Amilan CM3001-N, manufactured by Toray Industries, Inc.).
PA6: nylon 6 (Model number: CM1017, manufactured by Toray Industries, Inc.).

### <Thermoplastic Fluorine Resin>

THV-1: tetrafluoroethylene-hexafluoropropylene-vinylidenefluoride copolymer (Model number: THV 221GZ, tensile elongation: 600%, tensile stress: 20 MPa, manufactured by Sumitomo 3M Limited).
THV-2: tetrafluoroethylene-hexafluoropropylene-vinylidenefluoride copolymer (Model number: THV500, tensile elongation: 500%, tensile stress: 28 MPa, manufactured by Sumitomo 3M Limited).
THV-3: tetrafluoroethylene-hexafluoropropylene-vinylidenefluoride copolymer (Model number: THV610, tensile elongation: 500%, tensile stress: 28 MPa, manufactured by Sumitomo 3M Limited).
THV-4: tetrafluoroethylene-hexafluoropropylene-vinylidenefluoride copolymer (Model number: THV810, tensile elongation: 430%, tensile stress: 29 MPa, manufactured by Sumitomo 3M Limited).
ETFE: tetrafluoroethylene-ethylene copolymer (Model number: NEOFLON EP521, tensile elongation: 550%, tensile stress: 25 MPa, manufactured by Daikin Industries, Ltd.).

### <Substitutes for Thermoplastic Fluorine Resin>

SEBS: styrene-ethylene-butylene-styrene block copolymer (Model number: TUFTEC H1053, tensile elongation: 550%, tensile stress: 24.6 MPa, manufactured by Asahi Kasei Corporation).
Rubber: synthesis rubber (chloropyrene rubber) obtained by polymerization of chloropyrene.

The tensile elongation and tensile stress of the thermoplastic fluorine resins and substitutes therefor were measured according to ASTM D638.

### <Carbon Fiber>

Carbon fiber-1: polyacrylonitrile-based carbon fiber (trade name: PYROFIL, average fiber diameter: 7 μm, manufactured by Mitsubishi Rayon Co., Ltd.).
Carbon fiber-2: pitch-based carbon fiber (trade name: DIALEAD, average fiber diameter: 11 μm manufactured by Mitsubishi Plastics, Inc.).
Carbon fiber-3: carbon nanotube (trade name: VGCF-X, average fiber diameter: 0.012 μm, manufactured by Showa Denko K.K.).

### <Substitutes for Carbon Fiber>

Carbon powder: conductive carbon black (trade name: KETJENBLACK, manufactured by Ketjen Black International Company).
Metal powder: stainless steel powder (trade name: SUS TECH, manufactured by JFE Techno-Research Corporation).

### Measurement and Evaluation

### <Confirmation of Phase Separated Structure>

The phase separated structure of the thermoplastic resin composition was checked by forming the thermoplastic resin composition into a multipurpose test specimen shape prescribed by JIS K 7139 through injection, and observing a cross-section at the linear portion of the center as a measurement sample with a scanning electron microscope.

The phase separated structure of the sea-island shape in which the thermoplastic fluorine resin is dispersed in the polyamide is defined as a “sea-island structure” and the phase separated structure of the bicontinuous structure which is formed by the thermoplastic fluorine resin and the polyamide is defined as a “bicontinuous structure”.

### <Measurement of the Average Particle Size of Thermoplastic Fluorine Resin in Thermoplastic Resin Composition Having the Sea-Island Structure>

When the phase separated structure of the thermoplastic resin composition has the sea-island structure as shown in FIG. 1, the island structure (dispersed phase) of the thermoplastic fluorine resin was observed while gradually increasing a magnification from a low magnification by focusing on a point randomly selected on a measurement sample. When the observed island structures were equal to or more than 50 and less than 100, the particle size of the island structure was measured. Such a procedure was repeatedly performed with respect to 10 points, and the average value was defined as the average particle size of the thermoplastic fluorine resin.

### <Measurement of the Average Interphase Distance of Polyamide in Thermoplastic Resin Composition Having the Bicontinuous Structure>

When the phase separated structure of the thermoplastic resin composition has the bicontinuous structure as shown in FIG. 2. The magnification was gradually increased from a low magnification by focusing on a point was selected randomly on a measurement sample, and when a total of four strata of the polyamide and the thermoplastic fluorine resin were present with a square having a length a of a side, the interphase distance b of the polyamide was obtained by the following equation: b=a/2. Such procedure was repeatedly performed with respect to 10 points, and the average value was defined as the average interphase distance of the polyamide.

### <Measurement of the Average Fiber Diameter and the Aspect Ratio of Carbon Fiber>

The thermoplastic resin composition was formed into a multipurpose test specimen shape prescribed by JIS K 7139 through injection, and a range of 0.5 g to 1 g of the resin was cut out from the linear portion of the center thereof. After the resin component was dissolved using hexafluoroisopropanol, chloroform, acetone, methylethylketone, diethylether, formic acid, or concentrated sulfuric acid, from which only the carbon fiber was separated. The separated carbon fiber was observed with a scanning electron microscope, and the fiber diameter and the fiber length thereof were measured. The fiber diameter and the fiber length of each of 10 arbitrarily selected carbon fibers were measured. The average values there were defined as the average fiber diameter and the average fiber length of the carbon fiber, from which the aspect ratio was obtained.

### <Evaluation of Oil Resistance>

A test jig was manufactured by stacking ten pieces of lens-cleaning paper each of which has a thickness of 0.1 mm, and was then wound on a PTFE block having a width of 10 mm. The test jig was placed on the test sample, the lens-cleaning paper was sufficiently soaked in gasoline according to JIS K 2202, then a weight of 200 g was placed on the test jig, and the test jig was allowed to slide 3000 times in the longitudinal direction of the test sample. After sliding 3000 times, the surface state of the test sample was visually observed and was evaluated by the following evaluation criteria. In addition, gasoline was appropriately added to prevent the lens-cleaning paper from drying.

A: No change was observed and appearance was good.

B: White precipitate was deposited on the surface.

### <Evaluation of Impact Resistance>

The Izod impact strength of the test sample (23° C., notched) was measured according to ASTM D256 and evaluated by the following evaluation criteria.

A: Izod impact strength of equal to or greater than 500 J/m.

B: Izod impact strength of equal to or greater than 300 J/m, lower than 500 J/m.

C: Izod impact strength lower than 300 J/m

### <Evaluation of Conductivity>

A surface resistance value was measured using a surface resistance meter (Product Name: ST-3, manufactured by Simco Japan Inc.) and evaluated by the following evaluation criteria.

A: Surface resistance of equal to or lower than 1×10⁴Ω

B: Surface resistance higher than 1×10⁴Ω and equal to or lower than 1×10⁹

C: Surface resistance higher than 1×10⁹Ω

### Example 1

Each component was added to a biaxial kneader provided with a screw having a screw diameter of 20 mm according to a blending composition shown in Table 1, and was subjected to melting kneading at a temperature of 240° C. to obtain a thermoplastic resin composition. The phase separated structure of a resultant thermoplastic resin composition was checked and the average particle size of the thermoplastic fluorine resin or the average interphase distance of the polyamide was measured. Further, the average fiber diameter and the aspect ratio of the carbon fiber in the thermoplastic resin composition were measured. The results are shown in Table 1.

Subsequently, the resultant thermoplastic resin composition was formed into a multipurpose test specimen shape prescribed by JIS K 7139 through injection to obtain a molded article (test specimen). The resultant test specimen was cut at a linear portion (a length of 40 mm, a width of 10 mm, and a thickness of 4 mm) and prepared as a test sample, of which oil resistance and impact resistance were evaluated. In addition, a surface having a length of 40 mm and a width of 10 mm was used for a test surface. The results are shown in Table 1.

Separately, the resultant thermoplastic resin composition was used to be formed into a test specimen having a longitudinal length of 150 mm, a transverse length of 150 mm, and a thickness of 5 mm through injection, and the resultant test specimen was used to evaluate conductivity. The results are shown in Table 1.

### Examples 2 to 19, Comparative Examples 1 to 8

A thermoplastic resin composition was prepared, a test specimen was manufactured, and each measurement and evaluation was performed in the same manner as in Example 1, except that the blending composition of each component was changed as shown in Table 1 or 2. Results are shown in Tables 1 and 2.

In addition, with respect to Comparative Example 4, the aspect ratio of the carbon fiber in the thermoplastic resin composition was not obtained.

### Comparative Example 9

A sheet type molded article (test specimen) was manufactured, and each measurement and evaluation was performed in the same manner as in Example 1, except that a mixture (trade name: NORYL GTX 974, manufactured by Saudi Basic Industries Corporation (SABIC Co.)) of a polyamide, modified polyphenylene ether (m-PPE), and a carbon fiber was used. Results are shown in Table 2.

In addition, with respect to Comparative Example 9, the average fiber diameter and the aspect ratio of the carbon fiber in the mixture were not determined.

TABLE 1

| | | Blending composition of thermoplastic resin composition | | | | | | Phase separated structure of | |
|---|---|---|---|---|---|---|---|---|---|
| | | | | Thermoplastic fluorine resin | | Carbon fiber or | | thermoplastic resin composition | |
| | | Polyamide | | or substitutes therefor | | substitutes therefor | | | Average particle size |
| | | | Blending ratio | | Blending ratio | Kind | Blending ratio | | or average interphase |
| | | Kind | [pts. mass] | Kind | [pts. mass] | [pts. mass] | [pts. mass] | Structure | distance [μm] |
| Examples | 1 | PA11-A | 60 | THV-1 | 40 | Carbon | 5 | Sea-island | 5 |
| | | | | | | Fiber-1 | | structure | |
| | 2 | PA11-A | 60 | THV-1 | 40 | Carbon | 10 | Sea-island | 5 |
| | | | | | | Fiber-1 | | structure | |
| | 3 | PA11-A | 60 | THV-1 | 40 | Carbon | 20 | Sea-island | 5 |
| | | | | | | Fiber-1 | | structure | |
| | 4 | PA11-A | 60 | THV-1 | 40 | Carbon | 30 | Sea-island | 5 |
| | | | | | | Fiber-1 | | structure | |
| | 5 | PA11-A | 60 | THV-1 | 40 | Carbon | 50 | Sea-island | 5 |
| | | | | | | Fiber-1 | | structure | |
| | 6 | PA11-A | 80 | THV-1 | 20 | Carbon | 15 | Sea-island | 5 |
| | | | | | | Fiber-1 | | structure | |
| | 7 | PA11-A | 70 | THV-1 | 30 | Carbon | 15 | Sea-island | 5 |
| | | | | | | Fiber-1 | | structure | |
| | 8 | PA11-A | 50 | THV-1 | 50 | Carbon | 15 | Sea-island | 5 |
| | | | | | | Fiber-1 | | structure | |
| | 9 | PA11-A | 40 | THV-1 | 60 | Carbon | 15 | Sea-island | 5 |
| | | | | | | Fiber-1 | | structure | |
| | 10 | PA11-A | 30 | THV-1 | 70 | Carbon | 15 | Bicontinuous | 4 |
| | | | | | | Fiber-1 | | structure | |
| | 11 | PA12 | 60 | THV-1 | 40 | Carbon | 15 | Sea-island | 5 |
| | | | | | | Fiber-1 | | structure | |
| | 12 | PA66 | 60 | THV-1 | 40 | Carbon | 15 | Sea-island | 2 |
| | | | | | | Fiber-1 | | structure | |
| | 13 | PA6 | 60 | THV-1 | 40 | Carbon | 15 | Sea-island | 3 |
| | | | | | | Fiber-1 | | structure | |
| | 14 | PA11-A | 60 | THV-2 | 40 | Carbon | 15 | Sea-island | 1 |
| | | | | | | Fiber-1 | | structure | |
| | 15 | PA11-A | 60 | THV-3 | 40 | Carbon | 15 | Sea-island | 2 |
| | | | | | | Fiber-1 | | structure | |
| | 16 | PA11-A | 60 | ETFE | 40 | Carbon | 15 | Sea-island | 1 |
| | | | | | | Fiber-1 | | structure | |
| | 17 | PA11-A | 60 | THV-1 | 40 | Carbon | 20 | Sea-island | 5 |
| | | | | | | Fiber-2 | | structure | |
| | 18 | PA11-A | 60 | THV-1 | 40 | Carbon | 10 | Sea-island | 5 |
| | | | | | | Fiber-3 | | structure | |
| | 19 | PA11-B | 60 | THV-1 | 40 | Carbon | 15 | Sea-island | 5 |
| | | | | | | Fiber-1 | | structure | |

| | | Size of Carbon fiber in | | Evaluation | | | | |
|---|---|---|---|---|---|---|---|---|
| | | thermoplastic resin composition | | | Impact resistance | | Conductivity | |
| | | Average fiber | Aspect | Oil | Izod impact | | Surface resistance | |
| | | diameter [μm] | ratio | resistance | strength [J/m] | Evaluation | [Ω] | Evaluation |
| Examples | 1 | 7 | 140 | A | 580 | A | 10⁹ | B |
| | 2 | 7 | 74 | A | 570 | A | 10⁵ | B |
| | 3 | 7 | 28 | A | 560 | A | 10⁴ | A |
| | 4 | 7 | 19 | A | 540 | A | 10⁴ | A |
| | 5 | 7 | 15 | A | 450 | B | 10² | A |
| | 6 | 7 | 32 | A | 370 | B | 10⁴ | A |
| | 7 | 7 | 30 | A | 550 | A | 10⁴ | A |
| | 8 | 7 | 30 | A | 570 | A | 10⁴ | A |
| | 9 | 7 | 27 | A | 580 | A | 10⁴ | A |
| | 10 | 7 | 19 | A | 580 | A | 10⁴ | A |
| | 11 | 7 | 27 | A | 510 | A | 10⁴ | A |
| | 12 | 7 | 30 | A | 520 | A | 10⁴ | A |
| | 13 | 7 | 31 | A | 450 | B | 10⁴ | A |
| | 14 | 7 | 17 | A | 480 | B | 10⁴ | A |
| | 15 | 7 | 25 | A | 320 | B | 10⁴ | A |
| | 16 | 7 | 20 | A | 400 | B | 10⁴ | A |
| | 17 | 11 | 28 | A | 510 | A | 10⁴ | A |
| | 18 | 0.012 | 55 | A | 520 | A | 10⁴ | A |
| | 19 | 7 | 30 | A | 510 | A | 10⁴ | A |

TABLE 2

| | | Blending composition of thermoplastic resin composition | | | | | | Phase separated structure of | |
|---|---|---|---|---|---|---|---|---|---|
| | | | | Thermoplastic fluorine | | Carbon fiber or | | thermoplastic resin composition | |
| | | Polyamide | | resin or substitutes therefor | | substitutes therefor | | | Average particle size |
| | | | Blending ratio | | Blending ratio | | Blending ratio | | or average interphase |
| | | Kinds | [pts. mass] | Kinds | [pts. mass] | kinds | [pts. mass] | Structure | distance [μm] |
| Comparative | 1 | PA11-A | 60 | THV-1 | 40 | Carbon | 70 | Sea-island | 5 |
| Examples | | | | | | Fiber-1 | | structure | |
| | 2 | PA11-A | 90 | THV-1 | 10 | Carbon | 15 | Sea-island | 5 |
| | | | | | | Fiber-1 | | structure | |
| | 3 | PA11-A | 40 | THV-4 | 60 | Carbon | 15 | Sea-island | 2 |
| | | | | | | Fiber-1 | | structure | |
| | 4 | PA11-A | 60 | SEBS | 40 | Carbon | 15 | Sea-island | 8 |
| | | | | | | Fiber-1 | | structure | |
| | 5 | PA11-A | 60 | Rubber | 40 | — | — | Sea-island | 8 |
| | | | | | | | | structure | |
| | 6 | PA11-A | 60 | Rubber | 40 | Carbon | 15 | Sea-island | 6 |
| | | | | | | Fiber-1 | | structure | |
| | 7 | PA11-A | 60 | THV-1 | 40 | Carbon | 30 | Sea-island | 5 |
| | | | | | | powder | | structure | |
| | 8 | PA11-A | 60 | THV-1 | 40 | Metal | 40 | Sea-island | 5 |
| | | | | | | powder | | structure | |

| | | | |
|---|---|---|---|
| 9 | Mixture of polyamide/m-PPE/carbon fiber | — | — |

| | | Size of Carbon fiber in | | Evaluation | | | | |
|---|---|---|---|---|---|---|---|---|
| | | thermoplastic resin composition | | | Impact resistance | | Conductivity | |
| | | Average fiber | Aspect | Oil | Izod impact | | Surface resistance | |
| | | diameter [μm] | ratio | resistance | strength [J/m] | Evaluation | [Ω] | Evaluation |
| Comparative | 1 | 7 | 8 | A | 170 | C | 10¹ | A |
| Examples | 2 | 7 | 44 | A | 110 | C | 10⁴ | A |
| | 3 | 7 | 28 | A | 130 | C | 10⁴ | A |
| | 4 | 7 | — | B | 310 | B | 10⁴ | A |
| | 5 | — | — | B | 350 | B | 10¹² | C |
| | 6 | 7 | 38 | A | 220 | C | 10⁴ | A |
| | 7 | — | — | A | 140 | C | 10⁶ | B |
| | 8 | — | — | A | 140 | C | 10⁷ | B |
| | 9 | — | — | B | 170 | C | 10² | A |

As can be seen from Table 1, the molded articles obtained in respective Examples had good oil resistance, good impact resistance, and good conductivity.

On the other hand, as can be seen from Table 2, the molded article obtained in Comparative Example 1 in which the amount of the blended carbon fiber was 70 parts by mass had deteriorated impact resistance.

In Comparative Example 2, the molded article made from a material in which the amount of the blended polyamide was 90 parts by mass and the amount of the blended thermoplastic fluorine resin was 10 parts by mass. The molded article obtained in Comparative Example 2 was inferior in impact resistance.

In Comparative Example 3, the molded article made from the thermoplastic fluorine resin (THV-4) having a tensile elongation of 430%. The molded article obtained in Comparative Example 3 was inferior in impact resistance.

In Comparative Example 4, the molded article made from SEBS instead of the thermoplastic fluorine resin. The molded article obtained in Comparative Example 4 was inferior in oil resistance.

In Comparative Example 5, the molded article made from rubber instead of the thermoplastic fluorine resin and which included no carbon fiber. The molded article obtained in Comparative Example 5 was inferior in oil resistance and conductivity.

In Comparative Example 6, the molded article made from rubber instead of the thermoplastic fluorine resin. The molded article obtained in Comparative Example 6 was inferior in impact resistance.

In Comparative Examples 7 and 8, the molded articles made from carbon powder or metal powder instead of the carbon fiber. The molded articles obtained in Comparative Examples 7 and 8 were inferior in impact resistance.

In Comparative Example 9, the molded article made from the mixture of the polyamide, modified polyphenylene ether, and the carbon fiber. The molded article obtained in Comparative Example 9 was inferior in oil resistance and impact resistance.

Preferable Examples of the present invention were described above, but the present invention is not limited thereto. Addition, removal, replacement of a component, and other modifications can be made without departing from the scope of the present invention. The present invention is not limited to the aforementioned description, and is limited only by the attached Claims.

What is claimed is:

1. A thermoplastic resin composition, comprising:
30 to 80 parts by mass of a polyamide, 20 to 70 parts by mass of a thermoplastic fluorine resin, and a carbon fiber,
wherein a total sum of the polyamide and the thermoplastic fluorine resin is 100 parts by mass,
wherein an amount of the carbon fiber is 5 to 50 parts by mass based on 100 parts by mass of the total sum of the polyamide and the thermoplastic fluorine resin, and
wherein the thermoplastic fluorine resin has a tensile elongation of equal to or greater than 450%, and a tensile stress of equal to or greater than 5 MPa.

2. The thermoplastic resin composition according to claim 1, wherein
the carbon fiber has an average fiber diameter of 0.01 to 50 μm and an aspect ratio (i.e., average fiber length/average fiber diameter) of 10 to 200.

3. The thermoplastic resin composition according to claim 1, wherein
the thermoplastic resin composition has a phase separated structure of a sea-island-like shape in which the thermoplastic fluorine resin is dispersed in the polyamide, and in which the thermoplastic fluorine resin has an average particle size of equal to or smaller than 10 μm.

4. The thermoplastic resin composition according to claim 2, wherein
the thermoplastic resin composition has a phase separated structure of a sea-island-like shape in which the thermoplastic fluorine resin is dispersed in the polyamide, and in which the thermoplastic fluorine resin has an average particle size of equal to or smaller than 10 μm.

5. The thermoplastic resin composition according to claim 1, wherein
the thermoplastic resin composition has a phase separated structure in which a bicontinuous structure of the thermoplastic fluorine resin and the polyamide is formed, and in which the polyamide has an average interphase distance of equal to or smaller than 10 μm.

6. The thermoplastic resin composition according to claim 2, wherein
the thermoplastic resin composition has a phase separated structure in which a bicontinuous structure of the thermoplastic fluorine resin and the polyamide is formed, and in which the polyamide has an average interphase distance of equal to or smaller than 10 μm.
